(19) United States
(12) Patent Application Publication
(10) Pub. No.: US 2008/0294382 A1
(43) Pub. Date: Nov. 27, 2008

(54) Method and apparatus for pump fault prediction

(75) Inventors: Ki-hwan Lim, Osan-si (KR); Tae-ho Kim, Suwon-si (KR); Seung-ki Chae, Seoul (KR); Sang-gon Lee, Hwaseong-si (KR); Byoung-hoon Moon, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/149,938

(22) Filed: May 9, 2008

(30) Foreign Application Priority Data
May 21, 2007 (KR) 10-2007-0049324

(51) Int. Cl. G21C 17/00

(52) U.S. Cl. 702/185

(57) ABSTRACT

Example embodiments relate to a method and apparatus for pump fault prediction. A method of predicting a pump fault according to example embodiments may include collecting data in real time for qualitative variables associated with a pump and a corresponding semiconductor fabricating process, wherein the pump is configured to create a vacuum in a chamber during the semiconductor fabricating process. Principal components may be identified based on the collected data. Principal components exerting a primary influence on the operation of the pump may be selected from the identified principal components. A management variable may be generated to represent variations of the selected principal components. The management-variable may be monitored in real time to predict a pump fault. A pump fault prediction apparatus according to example embodiments may include a sensor connected to a pump to collect data in real time for qualitative variables associated with the pump and a corresponding semiconductor fabricating process. A controller may be connected to the sensor and may determine that the pump is in an abnormal state if the management variable (e.g., T² value) exceeds an upper control line.

### PRIORITY STATEMENT

This application claims priority under 35 U.S.C. §119 to Korean Patent Application No.10-2007-0049324, filed on May 21, 2007 in the Korean Intellectual Property Office (KIPO), the entire contents of which are incorporated herein by reference.

### BACKGROUND

1. Technical Field

Example embodiments relate to a method and apparatus for pump fault prediction, wherein the performance of a vacuum pump in a semiconductor fabricating process may be analyzed so as to predict the failure of the pump.

2. Description of the Related Art

Relevant process data may be collected in real time using sensors installed on a semiconductor fabrication line. The collected data may be processed, and the fabricating conditions may be monitored to detect and diagnose a process fault in advance. The term “fault” may refer to a malfunction, failure, and/or other defect that hinders the fabrication process.

A semiconductor fabrication process may be performed in a vacuum. Consequently, if a vacuum pump has problems, then the operation ratio may decrease, thereby reducing yield due to wafers being damaged by the vacuum break. Although a semiconductor fabrication process may include a plurality of pumps, a single pump malfunction may stop the entire process. For instance, a vacuum pump in a plasma process, a chemical vapor deposition (CVD) process, or a similar process may experience frequent malfunctions, because powder may stick to the inside of the pump as a result of the process gas used for forming thin films on silicon wafers. Thus, it may be beneficial to predict the time and location of a pump malfunction to avoid interrupting the process, thereby preventing or alleviating yield reduction.

Pump maintenance in a conventional semiconductor fabrication process may be performed according to a breakdown maintenance (BM) system, wherein a pump is replaced only when the process stops as a result of an inoperable pump. Although such a breakdown maintenance system monitors pump parameters to determine in real time whether the pumps are malfunctioning, it may be difficult to predict pump malfunctions, because even pumps of the same model made by the same manufacturer may differ from each other with regard to the occurrence of failures.

Methods for process monitoring may be categorized into three groups: 1) methods involving establishing an analytical model of a process and comparing a predicted value from the analytical model with data collected from a real process; 2) methods involving predicting a process condition with a knowledge-based model; and 3) methods involving comparing a predicted process condition obtained using statistical process control (SPC) graphs with a real process condition.

The analytical model approach may be the most direct monitoring method. However, the problem with this method is that the reliability of the prediction may be ensured only when an exact analytical model that fully factors all potential errors or faults can be established. Additionally, the parameters of the analytical model should be updated in real time, which may deteriorate system efficiency.

The knowledge-based approach may include an expert system, a method involving a neural network, or a similar system/method. The advantage of the knowledge-based approach is that the specific analytical model of a process is not required. However, a knowledge-based approach using an expert system may require a relatively experienced expert for the process, and a method involving a neural network may require a relatively large amount of learning data to configure an appropriate model.

The statistical process control (SPC) approach improves process productivity and product quality by using statistical techniques. The advantage of the statistical process control (SPC) approach is that a process condition may be analyzed or predicted by directly processing data for the process using statistical techniques, provided that the process data can be collected. A conventional SPC method may be suitable when monitoring independent variables. However, it may be difficult to apply the method when the correlations among the variables are relatively complicated. Because a conventional SPC method may be more appropriate with regard to monitoring one or two independent variables, performance may be relatively low when the process analysis and prediction involves an increased number of variables or a relatively high correlation among the variables. While a univariate prediction algorithm has been widely used, a multivariate prediction algorithm that considers the correlation of multivariate data has been seldomly used in spite of considerable theoretical studies.

### SUMMARY

Example embodiments relate a method and apparatus for pump fault prediction, wherein improved predictability may be achieved by considering the correlation of multivariate data from a plurality of qualitative variables. A method of predicting a pump fault according to example embodiments may include collecting data in real time for qualitative variables associated with a pump and a corresponding semiconductor fabricating process, wherein the pump is configured to create a vacuum in a chamber during the semiconductor fabricating process. Principal components may be identified based on the collected data. Principal components that influence the operation of the pump may be selected from the identified principal components. A management variable may be generated to represent variations of the selected principal components. The management variable may be monitored in real time to predict a pump fault.

Identifying the principal components may include defining a principal component model corresponding to a linear combination of an eigenvector and the qualitative variables using data collected when the pump and corresponding semiconductor fabricating process are in a normal state. The management variable may include a T² value. If the T² value exceeds an upper control line, it may be determined that the pump is in an abnormal state. The determination of an abnormal state may provide an early warning that a pump fault is forthcoming. As a result, it may be beneficial to schedule a maintenance time and a replacement time for the pump prior to the actual malfunction or failure of the pump. The qualitative variable causing the abnormal state may be detected by comparing contribution levels of the qualitative variables.

A maintenance time and/or replacement time of the pump may be determined by monitoring a change or transition in the contribution level of the qualitative variable causing the abnormal state. The maintenance time and/or replacement time of the pump may also be determined by comparing data of the qualitative variable causing the abnormal state with data of the other qualitative variables. Additionally, the maintenance time and/or replacement time of the pump may be determined by monitoring an accumulated sum of the qualitative variables. Furthermore, the maintenance time and/or replacement time of the pump may be determined by monitoring a correlation of the qualitative variables.

A database may be provided to classify the qualitative variable causing the abnormal state by fault type. The fault type of the pump may be determined by comparing data of the qualitative variable causing the abnormal state with the database. A common qualitative variable causing the abnormal state with regard to different fault types may be identified, and at least one of a maintenance time and a replacement time of the pump may be determined by monitoring data of the common qualitative variable. For instance, the common qualitative variable may be an inflow amount of nitrogen gas supplied to the pump.

The principal components may be identified when the pump and corresponding semiconductor fabricating process are in a normal state. The data may be collected for one or more wafers in the semiconductor fabricating process at regular intervals over a period of time. The upper control line may be calculated by taking a square of the total number of qualitative variables. The data may be collected by a sensor connected to the pump and may be transmitted to a controller.

A pump fault prediction apparatus according to example embodiments may include a sensor connected to a pump to collect data in real time for qualitative variables associated with the pump and a corresponding semiconductor fabricating process, wherein the pump is configured to create a vacuum in a chamber during the semiconductor fabricating process. A controller may be connected to the sensor and configured to identify principal components of the data, select the principal components for analysis, monitor a T² value representing variations of the selected principal components in real time, and/or determine that the pump is in an abnormal state if the T² value exceeds an upper control line. The controller may calculate the upper control line by taking a square of the total number of qualitative variables.

The controller may define a principal component model corresponding to a linear combination of an eigenvector and the qualitative variables using data collected when the pump and corresponding semiconductor fabricating process are in a normal state. The controller may calculate the T² value in real time using the principal component model. The controller may also detect a qualitative variable causing the abnormal state by comparing contribution levels of the qualitative variables. Furthermore, the controller may predict a pump fault by performing at least one of monitoring a change in contribution level of the qualitative variable causing the abnormal state, providing a database to classify the qualitative variable causing the abnormal state by fault type, monitoring a common qualitative variable causing the abnormal state of the fault type, monitoring a cumulative sum of the qualitative variables, and monitoring a correlation of the qualitative variables.

### BRIEF DESCRIPTION OF THE DRAWINGS

The features and advantages of example embodiments may become more apparent upon review of the detailed description with reference to the attached drawings in which:

FIG. 1 is a Shewhart chart according to the conventional art;

FIG. 2 is a diagram of a pump fault prediction apparatus according to example embodiments;

FIG. 3 through FIG. 5 are graphs according to example embodiments illustrating T² values as a function of data collected over time for a pump;

FIG. 6 through FIG. 8 are contribution level charts according to example embodiments;

FIG. 9 and FIG. 10 are cumulative sum control charts according to example embodiments;

FIG. 11 through FIG. 14 are graphs describing a pump fault prediction method according to example embodiments; and

FIG. 15 and FIG. 16 are graphs illustrating the variation of process variables over time according to example embodiments.

### DETAILED DESCRIPTION OF EXAMPLE EMBODIMENTS

It will be understood that when an element or layer is referred to as being “on”, “connected to”, “coupled to”, or “covering” another element or layer, it may be directly on, connected to, coupled to, or covering the other element or layer or intervening elements or layers may be present. In contrast, when an element is referred to as being “directly on,” “directly connected to” or “directly coupled to” another element or layer, there are no intervening elements or layers present. Like numbers refer to like elements throughout the specification. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, e.g., “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

Example embodiments relate to a method and apparatus for analyzing data from a pump in a semiconductor fabricating process as well as data from the process so as to predict faulting (e.g., failure) of the pump using a statistical technique based on an initial state (e.g., normal state) of the pump. According to example embodiments, a model may be defined for managing a plurality of qualitative variables (e.g., process variables) from a relatively large number of pumps (e.g., several thousands of pumps) with improved predictability. To define the model, a principal component analysis (PCA) may be used to consider the correlation of multivariate data.

For principal component analysis, principal components that directly affect pump operation may be selected from a plurality of process variables. A management variable (e.g., a T² value) may be generated to represent the variation and dispersion of the principal components. An identity verification technique may be applied to the new management variable. A replacement time for a pump may be predicted before a pump fault actually occurs by using an information system to collect data related to the process variables and statistically processing the collected data. Therefore, early warning may be provided in addition to the prediction of pump faults.

For instance, 1000 pumps may be installed in a semiconductor fabricating process and each of the pumps may have five qualitative variables (e.g., process variables). According to the conventional art, 5000 qualitative variables may be checked in real time in an attempt to detect abnormal conditions in the pumps. However, it may be difficult or impossible to detect such abnormal conditions before one or more pumps actually break down. In contrast, according to example embodiments, a management variable may be created to represent all of the process variables, wherein the management variable may be monitored with respect to one or more control lines. Therefore, the maintenance time of a pump may be scheduled before the pump actually breaks down.

Monitoring numerous pump variables and semiconductor fabricating processes according to the conventional art may be inefficient. Consequently, according to example embodiments, principal components that represent all the variables may be identified, and a T² chart may be monitored as a parameter including the variation of the principal components. As a result, abnormal conditions of the pumps may be conveniently detected. Replacing a pump as soon as an abnormal state is detected (although a sizeable portion of the pump life still remains) may be more disadvantageous than pump replacement using a conventional breakdown maintenance approach. Therefore, it may be beneficial to determine a pump replacement time that is relatively close to the time when a pump fault will likely occur.

According to example embodiments, the pump replacement time may be determined by analyzing the correlation and contribution level after an abnormal condition of a pump is detected from a T² chart. Principal components may be extracted from qualitative variables related to a semiconductor fabricating process and a pump using a PCA method. The dispersion of the principal components may be observed, for instance, with a T² curve, and control lines may be generated. Thus, various qualitative variables relating to the pump and corresponding semiconductor fabrication process may be monitored in real time, principal components (e.g., two or three principal components) may be selected using a PCA algorithm, and the abnormal state of a pump may be detected by managing the dispersion of the selected principal components.

The theoretical aspect of monitoring a semiconductor fabricating process using a statistical method and predicting a pump fault will be described below. A statistical process control (SPC) method for monitoring semiconductor fabricating processes may utilize a statistical control chart. An example of a statistical control chart may include a conventional Shewhart chart.

A conventional method using the Shewhart chart may be as follows. Target variables to be monitored may be assumed to have a constant mean value and a constant dispersion as shown in Equation 1.

yₜ=m+eₜ [Equation 1]

where yₜ denotes the target variable to be monitored, m denotes a mean value, and eₜ denotes an independent random error having the dispersion s².

As a result, control lines may be obtained with a 95% reliability or a 99% reliability with data collected from real fabricating processes. The control lines may include an upper control line UCL, an upper warning line UWL, a center line CL, a lower warning line LWL, and a lower control line LCL. If the monitored variable is between the upper control line UCL and the lower control line LCL, the pump corresponding to the monitored variable may be determined to be in a statistical control state. On the other hand, if the monitored variable is not between the upper control line UCL and the lower control line LCL, the pump corresponding to the monitored variable may be determined to be in an abnormal state (e.g., out of control).

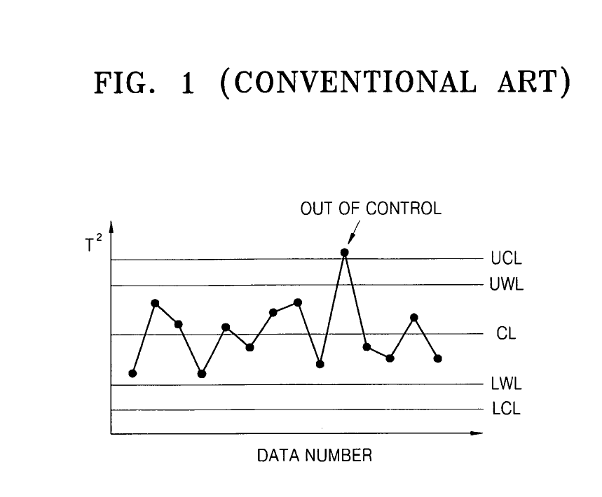

An abnormal state may be detected in a fabrication process when a special event changes a mean value or increases dispersion. Referring to FIG. 1, the monitored variable is shown to fall outside the upper control line UCL and the lower control line LCL, thus indicating an abnormal state. Once a fault is detected using the Shewhart chart, the cause of the fault may be determined, and the fabrication process may be corrected by removing the cause.

If a conventional statistic control chart method utilizes a univariate SPC method, numerical models may not be needed and the collected data may be directly used. Therefore, it may be relatively easy to apply the univariate SPC method to diagnose the collected data. However, the univariate SPC method may be disadvantageous in that it may be relatively difficult to apply it to multivariate situations involving numerous related variables. Nevertheless, an operator may still apply the univariate SPC method to multivariate processes if the variables are not significantly correlated to each other. When a univariate SPC method is used to monitor multivariate processes using the Shewhart chart with only principal components while the relatively small correlation of variables is ignored, an inappropriate result may occur.

For instance, a continuous reactor for inducing a gaseous reaction will be described below. The internal temperature of the reactor may increase if the internal pressure of the reactor increases. On the other hand, the internal temperature of the reactor may decrease if the internal pressure of the reactor decreases. If a univariate SPC method is applied to monitor the process of the continuous reactor by independently constructing Shewhart charts of the internal temperature and the internal pressure while ignoring the correlation between the internal temperature and the internal pressure, an incorrect result may occur.

The continuous reactor may be determined to be in a normal state because the monitored variables are between the control lines in the temperature Shewhart chart and the pressure Shewhart chart. However, the temperature may still be higher than a mean temperature and the pressure may still be lower than a mean pressure, which may not be normal in a gas state equation. As a result, an abnormal event of the continuous reactor may be incorrectly determined to be a normal event. Thus, if the temperature and pressure variables are independently monitored while the correlation between the temperature and pressure variables is ignored, an abnormal state may be incorrectly determined as a normal state. Consequently, an operator may continue to run the reactor in the abnormal state instead of taking suitable measures to correct the fault. Therefore, using a principal component analysis (PCA) based on multivariate statistical methods may be more appropriate for data having a relatively high correlation. In the PCA method, Hotelling's T-square distribution may be utilized in the context of multivariate statistical methods.

In a multivariate analysis (e.g., PCA), a data matrix X may be calculated as shown in Equation 2.

$$X = [ \vert \begin{matrix}{X}_{11}^{r} & {X}_{12}^{r} & ⋯ & ⋯ & ⋯ & {X}_{1 K}^{r} \\ {X}_{21}^{r} & {X}_{22}^{r} & ⋯ & ⋯ & ⋯ & {X}_{2 K}^{r} \\ ⋮ & ⋮ & ⋮ & & & ⋮ \\ ⋮ & ⋮ & & ⋮ & & ⋮ \\ ⋮ & ⋮ & & & ⋮ & ⋮ \\ {X}_{N 1}^{r} & {X}_{N 2}^{r} & ⋯ & ⋯ & ⋯ & {N}_{NK}^{r}\end{matrix} \vert ] \qquad [ Equation 2 ]$$

In the matrix X of Equation 2, N rows may denote objects. For example, N may be the total number of samples (e.g., total number of pumps or processes). Each row may denote each sample. K columns may denote variables. Each of columns may denote a measurement item of each sample. For example, each of the columns may be a temperature or an input power of a pump.

To diagnose the correlation of data, the PCA may define new axes that orthogonally cross each other, and orthogonal projection values may be calculated for the newly-defined axes. The newly-defined axes may be referred to as principal component axes PC. The orthogonal projection values may be obtained by reflecting data to principal component axes. The orthogonal projection values may be referred to as score vectors for the principal component axes. Data space may be analyzed using a principal component axes selected from the total principal component axes and orthogonal projection values projected to the selected principal component axes, but the data space analysis may not use all principal components and score vectors.

After the entire data space is approximated to a linear combination of a principal component axes and the orthogonal projection values, the approximated data space may be analyzed. When a principal components axes PC are selected, the first PC may be a vector that can describe the relationships of the variables in the data space (or the data matrix X) the best. The second PC may be a vector that can describe the relationships of the variables in the data space the second best. The a^{th} PC may denote a vector that can describe the relationships of the variables in the data space the a^{th} best. Therefore, if a is significantly large, the entire data space X may be approximated to a linear combination of the a representative relationships of the variables and score vector values (e.g., eigenvector).

If a mean value is subtracted from all data values of the data matrix X (e.g., centering) and if the data values are divided by a standard deviation (e.g., scaling), all data values of the data matrix X may be distributed between 0 and 1. After the centered and scaled data matrix X is obtained, a covariance matrix S may be calculated through matrix multiplication X^{T}X. Eigenvectors corresponding to each of column space of the covariance matrix S (S=X^{T}X) may be principal components that span the data space. The eigenvalues of each eigenvector may determine the range of the corresponding principal component direction.

A relatively large eigenvalue may mean that a larger dispersion of data distribution appeared in a corresponding principal component direction. When the principal component axes PC are sequentially defined, the principal component having the largest eigenvalue may be designated as the first PC, while the principal component having the second largest eigenvalue may be designated as the second PC. The entire data matrix may be approximated by selecting a principal components from the principal components having the largest eigenvalues.

A method of calculating a covariance matrix, an eigenvalue, and an eigenvector will be described below. Table 1 shows a data matrix formed of data collected based on, for instance, five social economical parameters (TOP, MSY, TOE, HSE, and MVH) for 14 regions. TOP denotes the total population, MSY denotes a middle tier of academic background, TOE denotes the total number of the employed, HSE denotes people in the medical service field, and MVH denotes the price of a middle tier house.

TABLE 1

| | TOP | MSY | TOE | HSE | MVH |
|---|---|---|---|---|---|
| 1 | 5.935 | 14.2 | 2.265 | 2.27 | 2.91 |
| 2 | 1.523 | 13.3 | 0.597 | 0.75 | 2.62 |
| 3 | 2.599 | 12.7 | 1.237 | 1.11 | 1.72 |
| 4 | 4.009 | 15.2 | 1.649 | 0.81 | 3.02 |
| 5 | 4.687 | 14.7 | 2.312 | 2.5 | 2.22 |
| 6 | 8.044 | 15.6 | 3.641 | 4.51 | 2.36 |
| 7 | 2.766 | 13.3 | 1.244 | 1.03 | 1.97 |
| 8 | 6.538 | 17 | 2.618 | 2.39 | 1.85 |
| 9 | 6.451 | 12.9 | 3.147 | 5.52 | 2.01 |
| 10 | 3.314 | 12.2 | 1.606 | 2.18 | 1.82 |
| 11 | 3.777 | 13 | 2.119 | 2.83 | 1.8 |
| 12 | 1.53 | 13.8 | 0.798 | 0.84 | 4.25 |
| 13 | 2.768 | 13.6 | 1.336 | 1.75 | 2.64 |
| 14 | 6.585 | 14.9 | 2.763 | 1.91 | 3.17 |

Table 2 shows a mean value and a standard deviation StD of the five variables.

TABLE 2

| | TOP | MSY | TOE | HSE | MVH |
|---|---|---|---|---|---|
| Mean | 4.323285714 | 14.01428571 | 1.952285714 | 2.171428571 | 2.454285714 |
| StD | 2.075465191 | 1.32946325 | 0.894800831 | 1.403379751 | 0.710197310 |

Table 3 shows a covariance matrix of the data matrix. The covariance matrix is a square matrix calculated by multiplying the data matrix and a transpose matrix of the data matrix.

TABLE 3

| | TOP | MSY | TOE | HSE | MVH |
|---|---|---|---|---|---|
| TOP | 4.307555758 | 1.683680220 | 1.683680220 | 2.155325714 | −0.253474396 |
| MSY | 1.683680220 | 1.767472527 | 0.588026374 | 0.177978022 | 0.175549451 |
| TOE | 1.802775989 | 0.588026374 | 0.800668527 | 1.064828022 | −0.158339011 |
| HSE | 2.155325714 | 0.177978022 | 1.064828022 | 1.969474725 | −0.356806593 |
| MVH | −0.253474396 | 0.175549451 | −0.158339011 | −0.356806593 | 0.504380220 |

The covariance may denote the strength of the linear relationship of two variables. For example, if the covariance of two variables x and y is positive, then the two variables may have a tendency to move in the same direction. On the other hand, if the covariance of two variables x and y is negative, then the two variables may have a tendency to move in opposite directions. However, if the covariance of two variables x and y is zero, then the two variables have no correlation. When two variables have no correlation, the variables are independent of each other.

A coefficient of correlation may be calculated by dividing a covariance of two variables by the product of the standard deviations of the two variables. A coefficient of correlation may have a value larger than −1 but smaller than 1. The coefficient of correlation may denote the relative strength of the linear relationship between two variables. If the coefficient of correlation is close to −1, then one variable may tend to decrease when the other variable increases. On the other hand, if the coefficient of correlation is close to 1, then one variable may tend to increase when the other variable increases. However, if the coefficient of correlation is close to 0, then the two variables have no correlation. Thus, if the coefficient of correlation is close to 0, then the two variables are independent of each other.

Methods using a covariance matrix and a coefficient of correlation may be used to calculate an eigenvector in the PCA. Because the variable units may differ from each other when various variables are considered, the covariance unit may also differ. The coefficient of correlation may be calculated by dividing a covariance by each standard deviation. Consequently, the units of the variables may be removed. As a result, the variables may be compared regardless of units.

Table 4 shows eigenvalues of the covariance matrix of the data matrix. Principal components PC1 to PC5 correspond to the size of the eigenvalues. As shown, the number of principal components generated equals the number of variables.

TABLE 4

| | Eigenvalue |
|---|---|
| PC1 | 6.93107 |
| PC2 | 1.78514 |
| PC3 | 0.38965 |
| PC4 | 0.22953 |
| PC5 | 0.01415 |

Table 5 shows eigenvectors of each principal component. Because it may be beneficial to calculate the eigenvectors from a square matrix, the eigenvectors may be calculated from the covariance matrix. The eigenvectors may orthogonally cross each other. As shown, the number of variables is 5. Consequently, the eigenvectors may be determined by solving a fifth degree equation. As many eigenvectors as the number of the eigenvalues may be calculated.

TABLE 5

| | PC1 | PC2 | PC3 | PC4 | PC5 |
|---|---|---|---|---|---|
| TOP | 0.781208 | 0.070872 | 0.003657 | −0.541710 | −0.302040 |
| MSY | 0.305649 | 0.763873 | −0.161817 | 0.544799 | −0.009280 |
| TOE | 0.334448 | −0.082908 | 0.014841 | −0.051016 | 0.937255 |
| HSE | 0.426008 | −0.579458 | 0.220453 | 0.636013 | −0.172145 |
| MVH | −0.054354 | 0.262355 | 0.961760 | −0.051276 | 0.024583 |

For example, the first principal component PC1 may be expressed as a linear combination of an eigenvector and the variables as shown in Equation 3 below. The other principal components PC2 to PC5 may similarly be expressed as a linear combination. Accordingly, the detailed descriptions thereof will be omitted in view of the discussion with regard to PC1.

PC1=(0.781208)*(TOP)+(0.305649)*(MSY)+(0.334448)*(TOE)+(0.426008)*(HSE)+(−0.054354)*(MVH) [Equation 3]

One problem when approximating a system by PCA is determining the number of principal components to select. To determine the proper number of principal components to select, an F-test may be used. An F-test is generally utilized in a statistical field or a nonlinear iterative partial least squares (NIPALS) method.

Selecting a smaller number of principal components (e.g., 1 to 3 principal components) to analyze multivariate data may be beneficial. Because the dispersion of each principal component may be identical to the eigenvalue, a ratio of each eigenvalue and the sum of the eigenvalues may be calculated. The calculated ratio may denote a ratio where each principal component describes the entire dispersion.

For instance, referring to Table 4, the first eigenvalue 6.93 may occupy about 74.14% of the sum of all eigenvalues (6.93+1.79+0.39+0.23+0.01) and may be a ratio describing the entire dispersion by the first principal component. Because an accumulated ratio describing the entire dispersion by first two principal components may be about 93.23% (74.14%+19.09%), the ratio of the first two principal components may be relatively high. Consequently, two principal components may be selected from among five principal components to represent the information of the five variables. Therefore, the equation degree may be reduced through PCA.

The variables represented by the selected principal components will be described below. Referring to Table 5, the first principal component PC1 has a positive eigenvector for four variables TOP, MSY, TOE, and HSE and a negative eigenvector for the fifth variable MVH. Thus, the variable MVH may have a different characteristic from the other variables TOP, MSY, TOE, and HSE in the first principal component PC1. The first principal component PC1 may be considered to be related to the number of people (TOP) and academic background (MSY).

Regarding the second principal component PC2, MSY (+) and MVH (+) may have different characteristics from TOE (−) and HSE (−). TOP (+) may move in the negative direction in view of the size of the absolute value and the characteristics of the variable. Therefore, the second principal component PC2 may be considered to divide the academic background (MSY) and the total number of people (TOP).

Once the principal components are obtained, the control lines may be established. The control lines may provide limits for determining whether a monitored variable is in an abnormal state (e.g., fault state) with respect to its correlation with the entire data. To set up the values of the control lines, a Hotelling T² chart may be used. In a univariate situation having a normal distribution, the distance from a mean value may be used to determine whether a predetermined event is in a normal state. In a multivariate situation (e.g., 2 or more variables) where the variables are independent of each other, the distance between each variable value and each mean value may be used to determine whether a predetermined event is in a normal state. However, if the variables have relatively high correlations in a multivariate situation, a Hotelling T² chart generated in consideration of the correlation of the entire data may be used to determine whether a predetermined event is in a normal state.

A sample covariance matrix S may be calculated from n multivariate samples, wherein Xᵢ is a column vector having the value of an i^{th} event, and X̅ denotes a mean vector.

$$S = {( n - 1 )}^{- 1} {\sum }_{i = 1}^{n} ( {X}_{i} - \overline{X} ) {( {X}_{i} - \overline{X} )}^{T} \qquad [ Equation 4 ]$$

A new multivariate data X may be a monitored variable that may be collected as a target verification value. A Hotelling T² may be calculated as shown in Equation 5.

T²=(X−τ)^{T}5⁻¹(X−τ) [Equation 5]

In Equation 5, τ denotes a mean value of data, which may be a target value. T² is a quadratic form of a deviation vector between a variable and a mean and may be drawn as a chart in a time series domain. T² may be used as a verification value of a monitored data X in a time series domain.

An upper control line (UCL) of T² is given as shown in Equation 6.

$${T}_{UCL}^{2} = \frac{( n - 1 ) ( n + 1 ) a}{n ( n - a )} {F}_{α} ( a , n - a ) \qquad [ Equation 6 ]$$

wherein Fₐ(a,n−a) is an upper 100a % critical point of a F distribution having the degree of freedom of a and n−a. n denotes the number of samples, a denotes the number of principal components, and 1−a denotes reliability. For example, the number a of principal components may be two, the number n of samples may be 15, and the reliability 1−a may be 95% (a=0.05). Consequently, the UCL value of T² is 8.21 because F_{0.05} (2, 13)=3.81.

An F-distribution table may include independent charts according to the reliability 1−a. A chart of a predetermined reliability 1−a may have a horizontal axis of the degree of freedom a and a vertical axis of the degree of freedom n−a. In an F-distribution table where the reliability may be 95% (a=0.05), the value Fₐ(a,n−a) may converge to 3.00 when the number of samples is about several hundred to infinity. Similarly, the value of Fₐ(a,n−a) may be 4.61 when the reliability is 99% (a=0.01).

The UCL value of T² may become a constant value when a relatively large number of sampling data are used for verification. Thus, if two principal components are selected and the reliability is about 95% (a=0.05), the UCL value of T2 may be 6.00 (3.00×2). Similarly, if two principal components are selected and the reliability is about 99% (a=0.01), the UCL value of T² may be 9.22 (4.61×2).

It may be possible to determine whether a process is in an abnormal state by monitoring one value T² although numerous variables may be related to the process. Unknown control lines may also be set. Because T² may be calculated based on a distance (square of deviation vector), a lower control line (LCL) of T² may be set to zero in a T² chart.

Referring to Equation 5, T² is the product of three factors: a variable, a mean deviation vector, and an inverse matrix of a covariance matrix. If the variables are independent from each other, then T² may be in proportion to the sum of the squared standardized variables, because the covariance matrix may be a diagonal matrix. The difference between a variable and its mean may become larger as T² increases. If T² exceeds the upper control line (UCL), the relevant variable may be in an abnormal state (e.g., out of control).

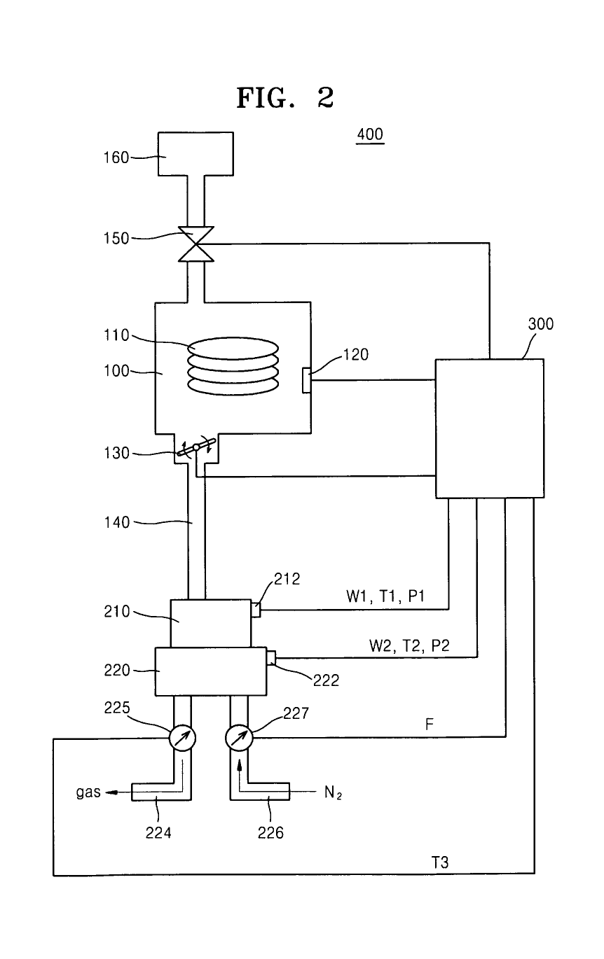

FIG. 2 is a diagram illustrating a pump fault prediction apparatus 400 according to example embodiments. A vacuum pump may create a vacuum in a chamber 100 during a semiconductor fabricating process. The vacuum pump may have a two-stage structure including a booster pump 210 connected to one side of the chamber 100 and a dry pump 220 connected to the atmospheric air. The two-stage structure may improve the vacuum level of the chamber 100. The booster pump 210 may include pump sensors 212 for transmitting the values for power W1, temperature T1, and pressure P1 from the booster pump 210 to a controller 300. The dry pump 220 may include pump sensors 222 for transmitting the values for power W2, temperature T2, and pressure P2 from the dry pump 220 to the controller 300.

A pressure sensor 120 may transmit the pressure value of the chamber 100 to the controller 300. A gas supply unit 160 may supply a process gas to the chamber 100 to form a thin film on a silicon wafer 110 during a fabrication process (e.g., plasma process, a chemical vapor deposition (CVD) process). A mass flow controller (MFC) 150 may be connected to the controller 300 and may control the amount of gas flowing into the chamber 100.

An exhaust gas may be discharged through an outlet 224 of the pump. The exhaust gas may include inactivated process gas and fine powders. As the exhaust gas moves farther from the chamber 100, the temperature of the exhaust gas may decrease. As a result, impurities (e.g., powders) may adhere to the inside surface of the pump or the pipe 140. The impurities may overload the pump and ultimately cause the pump to malfunction. To prevent impurities from sticking to the inside of the pump and cooling down the pump, nitrogen gas (N₂) may be injected into the pump through the inlet 226. The nitrogen gas and the process gas may be externally discharged through the outlet 224. Gas sensors 225 and 227 may be disposed in the outlet 224 and the inlet 226, respectively. The gas sensors 225 and 227 may be connected to the controller 300. The gas sensors 225 and 227 may transmit the values of the exhaust gas temperature T3 and the nitrogen gas inflow F, respectively, to the controller 300.

A throat valve 130 may be connected to the controller 300. The throat valve 130 may have an angle of rotation (APC-angle) that opens or closes the pipe 140 that connects the chamber 100 and the pump. If the rotation angle of the throat valve 130 is zero, then the throat valve 130 may be in a closed position. On the other hand, if the rotation angle of the throat valve 130 is larger than zero, then the throat valve 130 may be in an open position. When the chamber 100 and the pump are in an idle state, the throat valve 130 may be in a closed position. Because the throat valve 130 may be in an open position during the performance of a predetermined process, the pump may discharge the gas from the chamber 100 to the external environment so as to create a vacuum in the chamber 100.

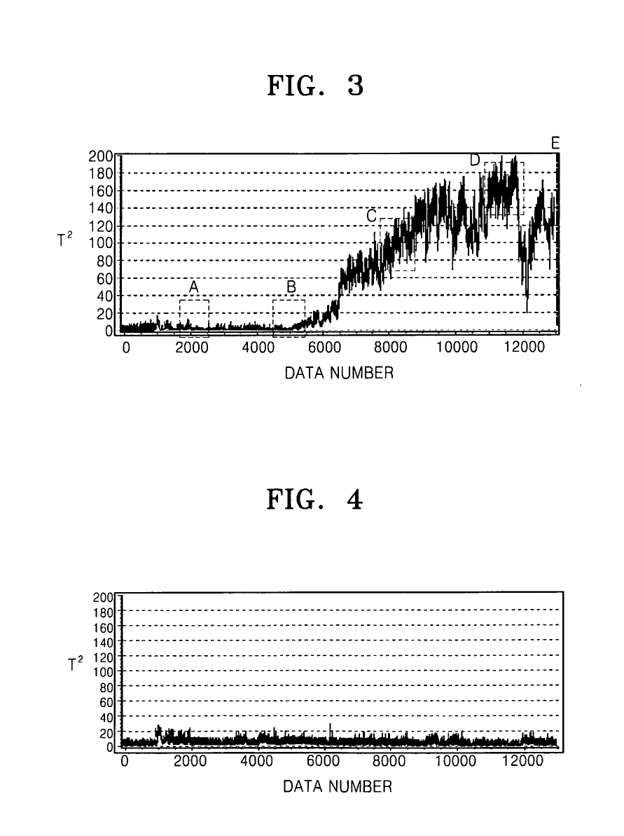

A method according to example embodiments for generating a prediction model of a pump using PCA will be described with reference to FIG. 3. FIG. 3 is a graph illustrating time-series T² values of a pump (T² Chart). A horizontal axis may represent the number of collected data. When the data is collected at regular intervals over time, the horizontal axis may also be indicative of the time elapsed after the initiation of data collection. Furthermore, if a first data is collected from a first wafer and a second data is collected from a second wafer, then the data number on the horizontal axis may be indicative of the number of wafers that have undergone the batch process.

A vertical axis may denote a T² value of a principal component model which may be selected by approximating the qualitative variables of the pumps and processes to the linear combination of Equation 3. In FIG. 3, reference marks A and B may denote periods when a pump is in a normal state. In contrast, reference marks C and D may denote periods when the pump is in an abnormal state. Reference mark E may represent a period when the pump stops because of a pump fault (e.g., malfunction).

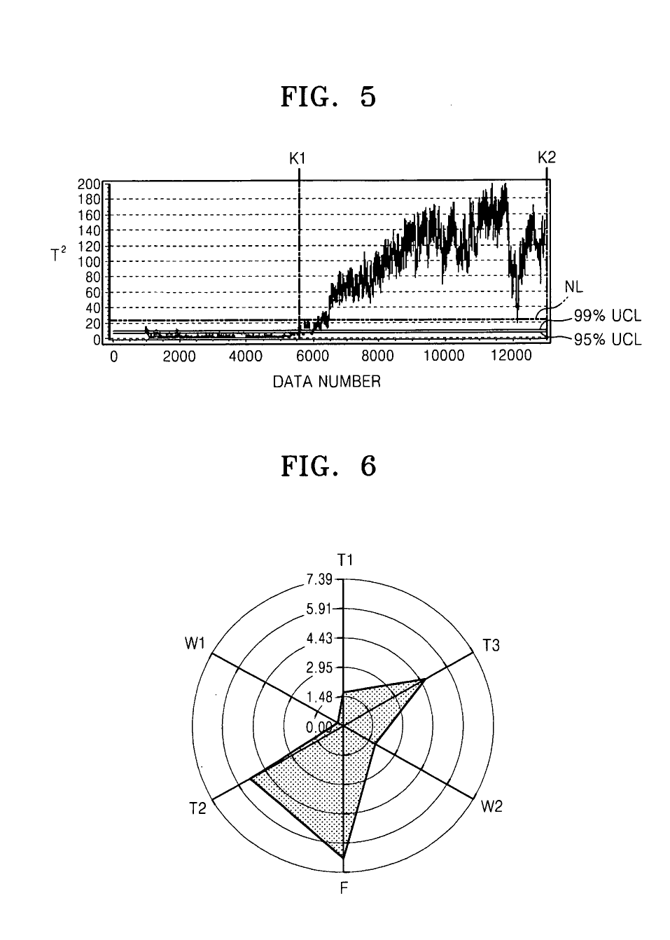

If a principal component model is set up using data collected when the pump is in a normal state, then a T² chart similar to FIG. 3 may be obtained. Therefore, the possibility of a pump fault may be detected using the T² chart. On the other hand, if a principal component model is set up using data collected when the pump is in an abnormal state, then a T² chart similar to FIG. 4 may be obtained. Consequently, the possibility of a pump fault may not be detected using such a T² chart, because the data may appear as a normal distribution within the local period, even though the data may otherwise indicate an abnormal state when viewed with respect to the entire period. Therefore, it may be beneficial for the principal component model to be set up using data collected when a pump and/or process is in an initial state (e.g., normal state). Such states may be shown by the periods indicated by reference marks A and B in FIG. 3 and the period before a reference line K1 in FIG. 5.

A method of setting up a principal component model according to example embodiments by measuring qualitative variables related to a pump (while excluding qualitative variables related to the process) will be described below. For example, with regard to setting up a principal component model for five qualitative variables, T1 may denote a temperature of a booster pump, W1 may denote the power of a booster pump (e.g., the power supply of the booster pump), T2 may denote a temperature of a dry pump, W2 may denote the power of a dry pump (e.g., the power supply of the dry pump), and F may denote the amount of nitrogen gas flowing into an inlet of the dry pump.

Because a coefficient of correlation may be calculated by dividing the covariance by each standard deviation, the units are not considered. Thus, the variables may be compared without regard to the units. Because the variables may have different units, the eigenvalues may be calculated using a correlation matrix rather than a covariance matrix. The sum of the eigenvalues may be identical to the number of variables.

A data matrix and a correlation matrix may be obtained using data for the qualitative variables T1, W1, T2, W2, and F. The data may be collected when the pump is in a normal state. Table 6 shows eigenvalues, the sum of the eigenvalues, dispersion rate, and accumulated rate of the correlation matrix. Because the number of the qualitative variables is five, the number of principal components PC1 to PC5 is five. Five eigenvalues may be calculated.

TABLE 6

| | Eigenvalue | Rate (%) | Accumulated Rate (%) |
|---|---|---|---|
| PC1 | 2.029 | 40.57 | 40.57 |
| PC2 | 1.047 | 20.94 | 61.51 |
| PC3 | 0.9997 | 19.99 | 81.5 |
| PC4 | 0.7629 | 15.26 | 96.76 |
| PC5 | 0.1619 | 3.237 | 100 |
| SUM | 5 | | |

The magnitude of the eigenvalue may correspond to the dispersion rate of a principal component. For instance, a principal component with a relatively large eigenvalue may have a relatively high dispersion rate. On the other hand, a principal component with a relatively small eigenvalue may have a relatively low dispersion rate. Consequently, a principal component with a relatively small eigenvalue may be ignored with regard to lowering the equation degree. It may be beneficial to select up to three principal components (although less than three may be selected). Alternatively, more than three principal components may be selected. Because the accumulated dispersion rate of the top three principal components is 81.5% as shown in Table 6, the top three principal components may represent characteristics of all the variables.

For purposes of illustration, the two principal components having the largest eigenvalue and the second largest eigenvalue may be selected from Table 6. The dispersion explanatory power of the two selected principal components PC1 and PC2 may be sufficient, because the accumulated dispersion rate is 61.51%. Thus, principal components PC1 and PC2 may be selected to lower the equation degree. Eigenvectors corresponding to the selected principal components PC1 and PC2 and eigenvalues thereof may be calculated. Table 7 shows the calculated eigenvectors corresponding to the principal components PC1 and PC2.

TABLE 7

| | PC1 | PC2 |
|---|---|---|
| T1 | −0.3933 | 0.3909 |
| W1 | −0.5425 | −0.5701 |
| T2 | 0.3509 | −0.7057 |
| W2 | 0.0163 | −0.0625 |
| F | −0.6539 | −0.1424 |

The principal component model may be defined by approximating the two principal components PC1 and PC2 to a linear combination of eigenvectors and qualitative variables T1, W1, T2, W2, and F. A T² chart as shown in FIG. 5 may be obtained by time serially substituting qualitative variables to monitor the principal component model during a predetermined time period.

A 95% UCL and a 99% UCL of FIG. 5 may be control lines of T² according to Hotelling's T-square distribution. The control lines may be applied as an ideal value for equipment control quality and driving condition. However, it may be difficult to determine whether a pump should be replaced at a time point K1 if the time point K1 is outside the control lines but still relatively far from a time point K2 when the operation of the pump actually stops.

If the replacement time of a pump is incorrectly determined, then the expense of using a pump fault prediction apparatus may be wasted. Referring to FIG. 5, if the number of data between the time points K1 and K2 is more than 8000, and 2000 data are collected in one month, then the time difference between the time points K1 and K2 may be longer than four months. Therefore, it may not be efficient to replace a pump at the time point K1 when the pump still has more than four months of life remaining.

Various methods may be used according to example embodiments to determine a replacement time that is closer to the likely occurrence of a pump fault. For instance, a new upper control line may be defined for T². A major variable causing a pump fault may be selected, and the contribution level of the selected major variable may be monitored. A cumulative sum control chart of the variables may be used. The correlation of the variables may also be monitored.

As described above, a new upper control line may be defined for the T² chart. In FIG. 5, a reference mark NL may denote a newly-defined upper control line according to example embodiments. The newly-defined upper control line for the T² chart may be defined as a square of the number of variables. For example, because the number of qualitative variables is 5, the newly defined upper control line may be 25 (5²). As described above, the size of an eigenvalue is correlated to the dispersion explanatory power of the corresponding principal component. T² may be a square type, and the sum of eigenvalues may be matched with the number of variables as shown in Table 6. The sum of the dispersion explanatory power of the principal components may become the sum of the eigenvalues, and the new upper control line of T² may be defined by squaring the number of variables, wherein the number of variables may be identical to the sum of the eigenvalues.

When the new upper control line NL of T² is exceeded, the qualitative variable causing the abnormal state may be determined by analyzing the data collected at the time point of the abnormal state. To analyze the collected data, a contribution level may be defined. Referring to Table 7, a contribution level of a variable T1 may be defined using Equation 7. A contribution level chart may be illustrated by assigning one point of a T² chart along a time transition.

(−0.3933)*(value of variable T1−mean value)/(standard deviation) [Equation 7]

Additionally, an exhaust gas temperature T3 of a dry pump outlet may also be used as a new variable to describe the contribution level in addition to the five variables T1, W1, T2, W2, and F, and a new principal component model may be defined.

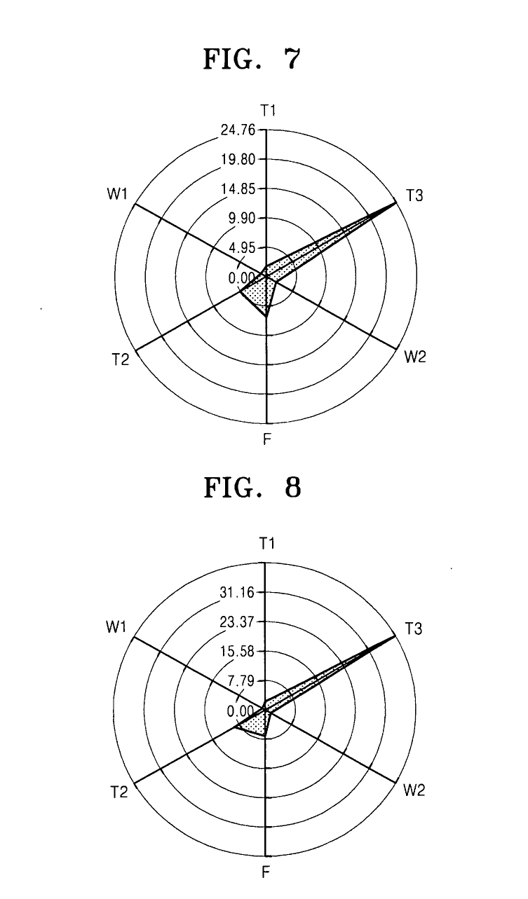

FIG. 6 is a contribution level chart for a period A or B in a T² chart of FIG. 3 when a pump is in a normal state. FIG. 7 is a contribution level chart for a period C or D in a T² chart of FIG. 3 when a pump is in an abnormal state. In the T² chart, the contribution level for the normal state period may have a different value from the contribution level for the abnormal state period. The contribution level of each variable in FIG. 6 is relatively uniform in that a variable having a relatively large contribution level is not observed. On the contrary, the contribution level of each variable in FIG. 7 is not uniform in that the contribution level of the variable T3 is relatively large.

Referring to FIG. 7, because the contribution level of the variable T3 has the largest value of about 22.5, it may be determined that the variable T3 is causing the abnormal state of the pump. For example, if FIG. 7 illustrates the contribution level of each variable at a time point approximately one month before the pump stops because of a pump fault, then FIG. 8 may illustrate the contribution level of each variable at a time point approximately one week before the pump stops because of a pump fault. In FIG. 8, the contribution of the variable T3 is about 31 and is comparatively larger than the contribution levels of the other variables. If a T² chart is referred to, it may be possible to determine whether the UCL of the T² chart has been exceeded at the time points of FIG. 7 and FIG. 8. However, a T² chart by itself will not indicate the variable that may be causing the abnormal state.

Relying only on a T² chart, it may be difficult to determine that the variable T3 is the major variable causing the abnormal state of a pump. Detecting the contribution level increase of T3 from 22.5 to 31 may also be difficult with only a T² chart. On the other hand, because the relatively large contribution level of the variable T3 is shown in FIG. 7, it may be possible to predict that the variable T3 will cause the pump fault. Also, because the contribution level of the variable T3 increases in FIG. 8, it may be possible to predict that the pump will stop in a relatively short period of time. Thus, the T² chart may be used to detect an abnormal state, and the contribution level chart may be used to detect the variable causing the abnormal state. The pump fault may be predicted by monitoring the variation of the contribution level of the variable causing the abnormal state.

The contribution level chart may be used to detect the variable that is most likely to cause a pump fault. The contribution level chart may also be used to determine the correlation between the pump fault type and the variable causing the fault. Table 8 illustrates the correlation between pump fault types and the variables causing the fault. Table 8 is an example of a database classifying such variables by pump fault types.

TABLE 8

| Fault type | Frequency | Causing variable |
|---|---|---|
| Rotor damage | 4 | F |
| Powder accumulation | 3 | W1, W2, F |
| Decreased rotation speed | 2 | F |
| Motor overload | 2 | T2, F |
| Clogged pipe | 1 | F |

As shown in Table 8, the variable F (nitrogen flow) is a common variable causing pump fault. The contribution level of the variable F is also higher than that of any other variable. According to Table 8, it may be possible to detect a pump fault by simply monitoring the nitrogen flow. If it is possible to extract a common variable causing a pump fault for each pump fault type, then a maintenance time and a replacement time may be determined by monitoring the common variable in real time without a T² chart.

When a pump is in a normal state, a value T2 may not exceed the control lines of a T² chart and the coefficient of correlation of each variable may be about constant. However, when the value T2 exceeds the control lines, then the coefficient of correlation of the variables may vary abruptly. Accordingly, the variation of the coefficient of correlations may be monitored. When a positive coefficient of correlation is monitored, a graph showing two variable values on a vertical axis and a horizontal axis may show an upward tendency in a right direction. On the other hand, when a negative coefficient of correlation is monitored, the graph may show a downward tendency in a right direction.

Therefore, the variation speed and direction of each variable may be monitored through the coefficient of correlation. Consequently, the predicted maintenance time and replacement time of a pump may be relatively close to the actual fault generation time of the pump. Furthermore, if the variation characteristics of the correlation coefficients were previously analyzed, then the fault generation type may also be predicted by monitoring the coefficient of correlation.

As described above, an abnormal state may be determined using a T² chart. A cumulative sum control chart (CUSUM) may be used to detect process variations. Because the CUSUM may be obtained by accumulating past data that have been inspected as well as current data, the variation of a process may be detected relatively quickly. Also, it may be possible to detect relatively subtle process variations when continuous sample data values are considered. If a Shewhart chart is used when a process varies relatively slowly, then it may be relatively difficult to detect the process variations. However, if a CUSUM chart is used, it may be possible to detect process variations about two times faster than the Shewhart chart.

A CUSUM chart may be obtained by regularly extracting n samples from a process and calculating a cumulative sum of the differences between the mean values of the extracted samples and a process expectation value (or target value). In a CUSUM chart, plotted points may be randomly distributed around 0. If the plotted points move upward and downward, then the mean value of the process may be changing. Such a change may serve as a warning with regard to an abnormal state.

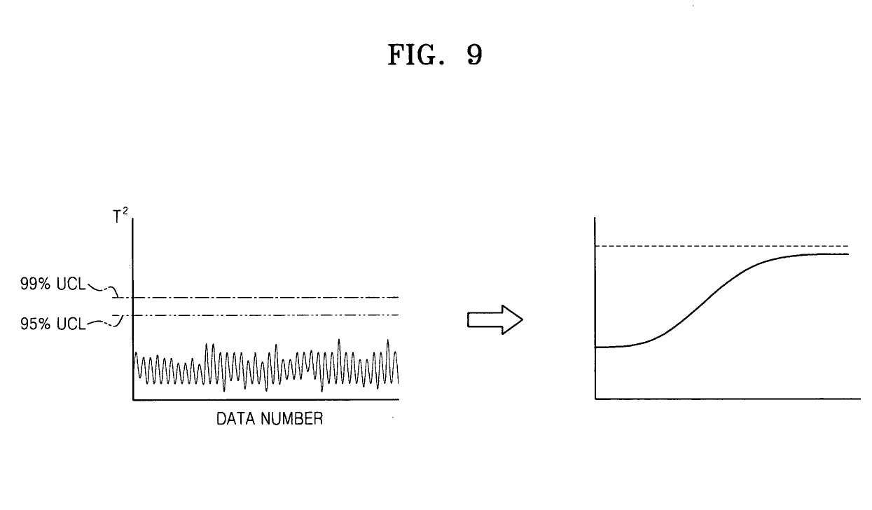

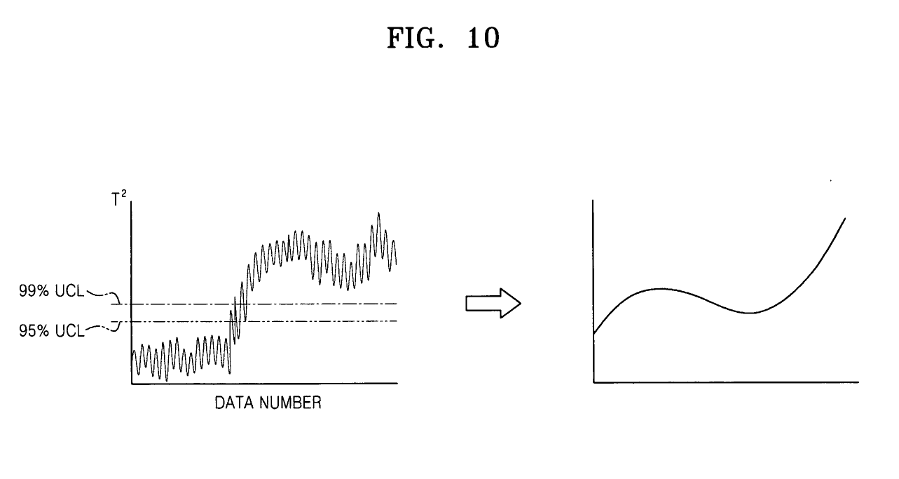

Referring to FIGS. 9-10, a T² chart is shown on the left side, and a CUSUM chart is shown on the right side. In FIG. 9, the values of T² are distributed within the control lines, and the variation mean values of the variables may be relatively constant. Accordingly, the transition of a corresponding CUSUM chart may converge. In FIG. 10, the values of T² increase and exceed the control lines, and the variation mean values of the variables is not constant. Accordingly, the transition of a corresponding CUSUM chart does not converge.

FIG. 11 through FIG. 14 are graphs describing a pump fault prediction method according to example embodiments. T² values may be monitored to determine whether they are distributed within the control lines using a T² chart as shown in FIG. 11. According to example embodiments, only T² values may be monitored to determine whether a pump is in an abnormal state. In contrast, numerous variables may be monitored in a conventional method. Therefore, determining the state of the pump may be relatively convenient by monitoring only T² values. When an abnormal state is detected from the T² chart because the T² values exceed the control line, the major variables causing the fault may be detected from the contribution level chart of each variable.

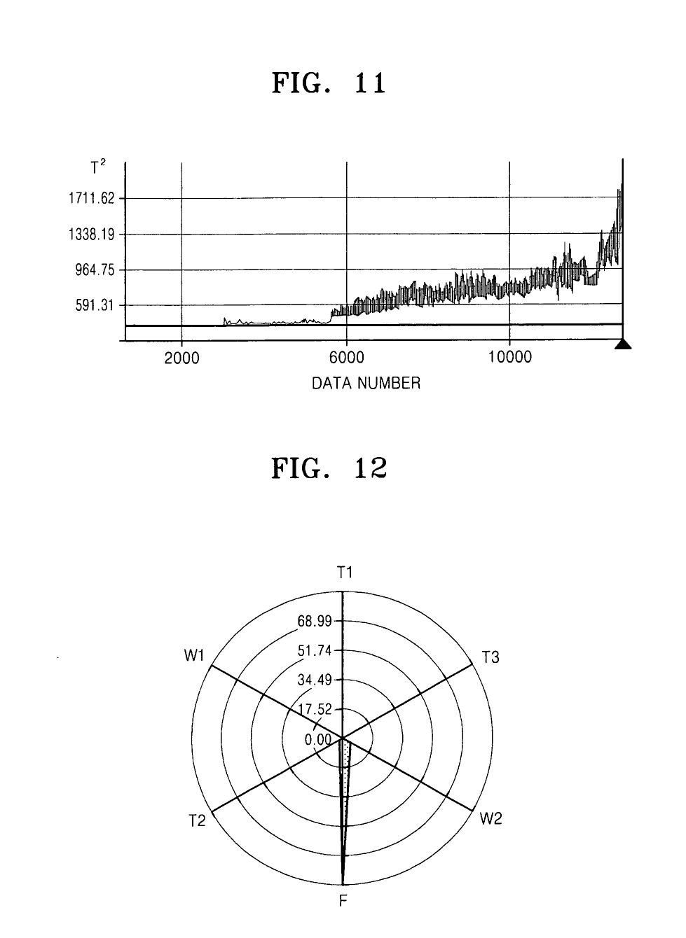

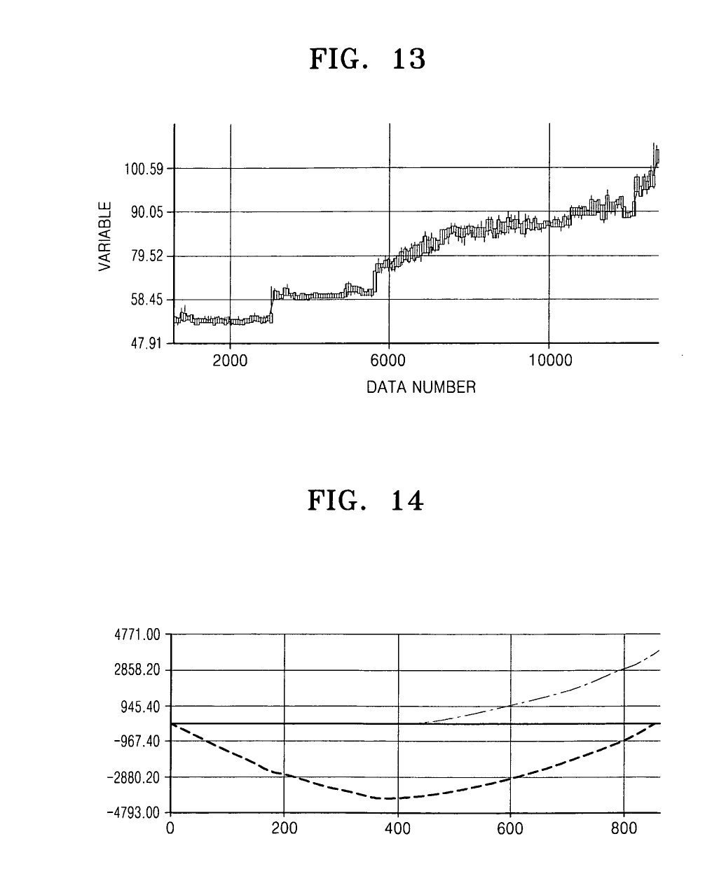

Referring to FIG. 12, a variable F (nitrogen gas inflow amount) may be selected as the variable causing the fault. The transition of the selected variable F may be time serially observed in FIG. 13. In the case of a variable having a relatively large contribution level, the transition may be similar to that of the T² chart. However, in the case of a variable having a relatively small contribution level, the transition may be distinct from that of the T² chart. The fault generation time of a pump may be predicted by monitoring the coefficient of correlation of the variable and the increasing tendency of the contribution level. Productivity may be improved by finding a maintenance time and a replacing time for the pump that is relatively close to the time when the fault will actually occur.

To observe relatively subtle variations of the variable causing the fault, it may be beneficial to use a cumulative sum control chart as shown in FIG. 14. When the transitions of the CUSUM change upwardly and/or downwardly, this may be considered a warning sign. As a result, the variation of the variable may be monitored with increased care.

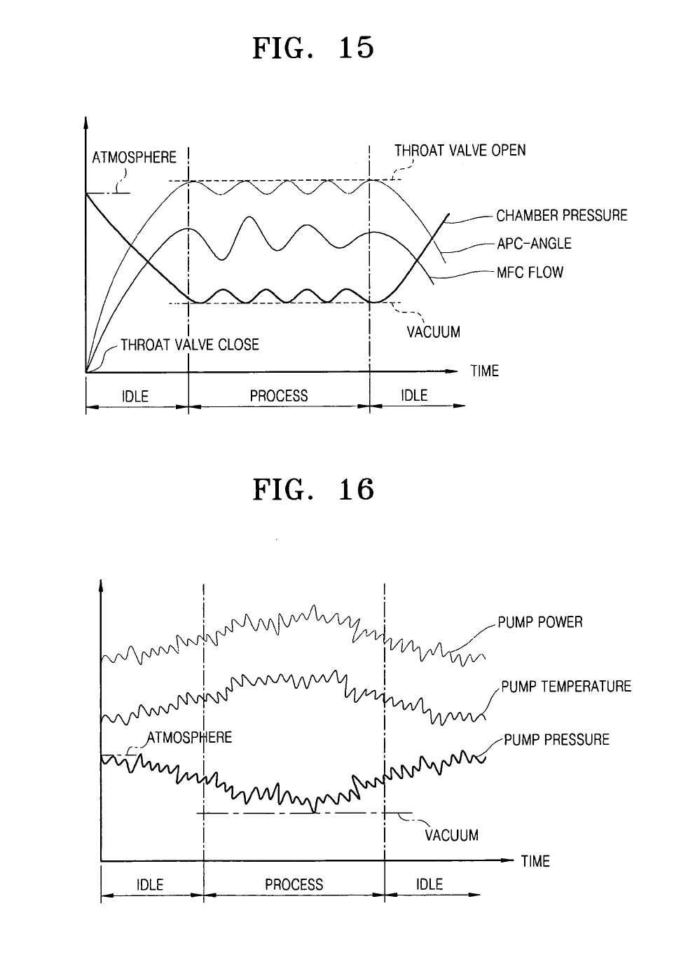

FIG. 15 and FIG. 16 are graphs showing transitions of variables in a time series domain. To predict a pump fault, variables related to the semiconductor fabricating process as well as variables related to the operating states of a pump may be analyzed using the principal component analysis (PCA). For example, pump-related variables including pump power, pump temperature, and pump pressure may be analyzed. Additionally, process-related variables including throat valve rotation angle (APC-angle), MFC flow, and chamber pressure may be analyzed through PCA. Therefore, it may be possible to determine whether a pump should undergo a maintenance procedure or whether the pump should be replaced by comparing data related to a variable having a relatively high contribution level with data related to other variables.

A pump may be in an idle state before the process starts or after the process ends. In the idle state, the pump power may not be supplied, the pump temperature may be relatively low, the pump pressure may be about equal to the air pressure, the throat valve may be in a closed position, the process gas may not be supplied to a chamber, and the chamber pressure may be about equal to the air pressure. The pump may operate when a predetermined process is in progress. In a process state, the pump power may be supplied, the pump temperature may increase, the pump pressure may correspond to a vacuum state, the throat valve may be in an open position, the process gas may be supplied to the chamber, and the chamber pressure may correspond to a vacuum state. Such a tendency may be reflected when variables causing a fault are diagnosed.

It may be beneficial to predict a pump fault in addition to identifying the cause of the fault by analyzing qualitative variables associated with the pump and the corresponding semiconductor fabricating process. Qualitative variables associated with a pump and a corresponding semiconductor fabricating process may have a relatively high correlation and the total number of such qualitative variables may not be large.

If variables related to pumps and their corresponding processes are included in PCA, it may be possible to accurately determine the maintenance time and/or replacement time of a pump after an abnormal state is detected and a variable causing the fault is identified. For example, if pump power is selected as the variable suspected of causing the fault by the contribution level chart or the cumulative sum control chart while the other variables show normal transitions as shown in FIG. 15 and FIG. 16, then it may be determined that the transition of the pump power variable may not be in an abnormal state. Therefore, it may be determined that the maintenance time and/or the replacement time of the pump has not yet been reached.

As described above, the pump fault prediction apparatus and the method according to example embodiments may sufficiently consider the correlation of multivariate data including numerous variables related to pumps and their corresponding semiconductor fabricating processes. Thus, the apparatus and method according to example embodiments may provide increased productivity associated with the maintenance and replacement of pumps. Accordingly, pumps may be repaired and/or replaced without process interruption and product yield deterioration may be reduced or prevented.

While example embodiments have been disclosed herein, it should be understood that other variations may be possible. Such variations are not to be regarded as a departure from the spirit and scope of example embodiments of the present disclosure, and all such modifications as would be obvious to one skilled in the art are intended to be included within the scope of the following claims.

What is claimed is:

1. A method of predicting a pump fault comprising:
collecting data in real time for qualitative variables associated with a pump and a corresponding semiconductor fabricating process, the pump configured to create a vacuum in a chamber during the semiconductor fabricating process;
identifying principal components of the data;
selecting principal components that influence operation of the pump;
generating a management variable to represent variations of the selected principal components; and
monitoring the management variable in real time to predict a pump fault.

2. The method of claim 1, wherein the management variable includes a T² value.

3. The method of claim 2, wherein monitoring the management variable includes determining that the pump is in an abnormal state when the T² value exceeds an upper control line.

4. The method of claim 3, further comprising:
comparing contribution levels of the qualitative variables to detect the qualitative variable causing the abnormal state.

5. The method of claim 4, further comprising:
determining at least one of a maintenance time and a replacement time of the pump by monitoring a change in the contribution level of the qualitative variable causing the abnormal state.

6. The method of claim 4, further comprising:
determining at least one of a maintenance time and a replacement time of the pump by comparing data of the qualitative variable causing the abnormal state with data of the other qualitative variables.

7. The method of claim 4, further comprising:
providing a database to classify the qualitative variable causing the abnormal state by fault type.

8. The method of claim 7, wherein the fault type is determined by comparing data of the qualitative variable causing the abnormal state with the database.

9. The method of claim 4, wherein a common qualitative variable causing the abnormal state with regard to different fault types is identified, and at least one of a maintenance time and a replacement time of the pump are determined by monitoring data of the common qualitative variable.

10. The method of claim 9, wherein the common qualitative variable is an inflow amount of nitrogen gas into the pump.

11. The method of claim 3, further comprising:
determining at least one of a maintenance time and a replacement time of the pump by monitoring an accumulated sum of the qualitative variables.

12. The method of claim 3, further comprising:
determining at least one of a maintenance time and a replacement time of the pump by monitoring a correlation of the qualitative variables.

13. The method of claim 1, wherein the principal components are identified when the pump and corresponding semiconductor fabricating process are in a normal state.

14. The method of claim 1, wherein the data is collected for one or more wafers in the semiconductor fabricating process at regular intervals over a period of time.

15. The method of claim 3, wherein the upper control line is calculated by taking a square of the total number of qualitative variables.

16. The method of claim 1, wherein the data is collected by a sensor connected to the pump and transmitted to a controller.

17. A pump fault prediction apparatus comprising:
a sensor connected to a pump to collect data in real time for qualitative variables associated with the pump and a corresponding semiconductor fabricating process, the pump configured to create a vacuum in a chamber during the semiconductor fabricating process;
a controller connected to the sensor and configured to identify principal components of the data, select the principal components for analysis, monitor a T² value representing variations of the selected principal components in real time, and determine that the pump is in an abnormal state if the T² value exceeds an upper control line.

18. The pump fault prediction apparatus of claim 17, wherein the controller
defines a principal component model corresponding to a linear combination of an eigenvector and the qualitative variables using data collected when the pump and corresponding semiconductor fabricating process are in a normal state, and
calculates the T² value in real time using the principal component model.

19. The pump fault prediction apparatus of claim 17, wherein the controller
detects a qualitative variable causing the abnormal state by comparing contribution levels of the qualitative variables, and
predicts a pump fault by performing at least one of monitoring a change in contribution level of the qualitative variable causing the abnormal state, providing a database to classify the qualitative variable causing the abnormal state by fault type, monitoring a common qualitative variable causing the abnormal state of the fault type, monitoring a cumulative sum of the qualitative variables, and monitoring a correlation of the qualitative variables.

20. The pump fault prediction apparatus of claim 17, wherein the controller calculates the upper control line by taking a square of the total number of qualitative variables.
